(19) United States
(12) Patent Application Publication
(10) Pub. No.: US 2023/0064085 A1
(43) Pub. Date: Mar. 2, 2023

(54) NUTRITIONAL COMPOSITION

(71) Applicant: Nara Organics, Inc., New York, NY (US)

(72) Inventors: C. Esther Park Hallam, Saugerties, NY (US); Jung Sian Ma, Brooklyn, NY (US); Juan M. Gonzalez, Barrington, IL (US); David Callam Clark, Englewood, FL (US); Daniel R. Heiges, Boulder, CO (US)

(73) Assignee: Nara Organics, Inc., New York, NY (US)

(21) Appl. No.: 17/858,318

(22) Filed: Jul. 6, 2022

Related U.S. Application Data
(60) Provisional application No. 63/234,273, filed on Aug. 18, 2021.

(51) Int. Cl. A23L 33/19; A23L 33/00; A23L 33/12; A23L 29/00

(52) U.S. Cl. CPC A23L 33/19; A23L 33/40; A23L 33/12; A23L 29/06

(57) ABSTRACT

The present disclosure provides a nutritional composition, such as an infant formula, including protein, fat and carbohydrates, wherein whole milk comprises a source of each of the protein, fat, and carbohydrates.

### TECHNICAL FIELD

The present disclosure relates generally to nutritional compositions that are suitable for administration to infants. More particularly, the disclosure relates to methods to support and promote healthy growth by including milk fat with its functional components without the need of supplementation with dairy lipid-enriched fractions. The composition of the present disclosure includes whole milk as a sole source of milk fat, including its milk fat globule membrane components, short chain fatty acids and branched chain fatty acids. In some embodiments, the compositions include a combination with one or more of prebiotics and long chain polyunsaturated fatty acids.

### BACKGROUND

Human milk provides the optimal nourishment to newborn infants; it is a complex matrix comprising diverse components that support infant growth and development. Milk fat is a natural macro component of milk. Milk fat is rich in triglycerides with fatty acids positioned in stereochemical arrangements that support optimal nutrient absorption; it also comprises functional polar and neutral lipids, glycoproteins and enzymes that are associated with infant development. However, milk fat and its benefits are absent in conventional infant formulas that rely on skim milk as a main component, since in skim milk its milk fat portion has been removed. In lieu, vegetable oils are used to meet the total nutritional fatty acid requirements. Supplementation with lipid-enriched whey fractions or buttermilk has also been used to provide milk fat bioactive components absent in skim milk, such as phospholipids, gangliosides, and cholesterol. Lipid content in human milk and bovine milk is about 30 g/L to 50 g/L and provides about 45% to 55% of the total energy requirements of the newborn mammal. Triglycerols are about 98% of the human and bovine milk fat, and are composed of about 200-400 diverse fatty acids. Although vegetable oils used to create a fatty acid profile can broadly match that of human milk fat, no vegetable oil blend can match the fatty acid diversity and functionality of milk fat. To circumvent this deficiency, in some cases, conventional infant formulas rely on supplementation with bovine lipid-enriched fractions. There is a need for a nutritional composition that delivers the benefits of milk fat in a simple low-cost method without the need of milk fat as an individual ingredient or lipid-fractions supplementation. The nutritional compositions of the present disclosure also include high-quality non-plant proteins, lipids, carbohydrates, long chain polyunsaturated fatty acids, and prebiotics.

Accordingly, the present disclosure is directed to a nutritional composition suitable for administration to an infant, that comprises a protein, fat, and carbohydrate source including whole milk. More specifically, the protein source may comprise whole milk powder, and provides a whey:casein ratio of about 50:50 to about 70:30 by weight. In some embodiments, the whole milk comprises at least about 18% of the composition.

### BRIEF SUMMARY

Briefly, therefore, the present disclosure is directed to a nutritional composition for providing nutritional support for a subject, such as an infant, and to methods for promoting healthy development of the subject. The present disclosure provides a nutritional composition comprising whole milk as a source of protein, fat and carbohydrates. In embodiments, the composition is substantially free of nonfat, defatted, or skim milk. In some embodiments, the composition(s) comprises whole milk from about 3 grams per 100 kcal (g/100 kcal) to about 5 g/100 kcal. In certain embodiments, in a powder format, whole milk is from about 17 grams per 100 grams (g/100 g) to about 26 g/100 g of composition. Furthermore, at these levels, the casein contained in whole milk in combination with whey ingredients enables a weight ratio of whey:casein from about 60:40 to about 70:30. When administered, the nutritional composition(s) disclosed herein provides sole source nutrition while promoting digestibility.

The disclosed nutritional composition includes whole milk at a level such that the whole milk provides at least about 35% of the protein and at least about 12% of the fat. In some embodiments, whole milk is the sole contributor of milk fat. Milk fat comprises about 15% to about 25% of the total fat of the composition(s); that is, about 6 grams per liter (g/L) to about 10 g/L. Furthermore, in embodiments, the milk fat contained in whole milk in combination with vegetable oils enables a weight ratio of milk fat:vegetable oil from about 1:3 to about 1:5. In some embodiments, the composition(s) is substantially free of palm oil, palm olein, palm kernel oil, and soybean oil.

In some embodiments, the nutritional composition of the present disclosure provides a fatty acid profile which helps promote healthy development in an infant. In some embodiments, the nutritional composition(s) disclosed herein provides milk fat globule membrane components without the need of supplementation, providing phospholipids from about 56 milligrams per liter (mg/L) to about 80 mg/L; sphingolipids from about 12 mg/L to about 18 mg/L; cholesterol from about 25 mg/L to about 35 mg/L; gangliosides from about 5 mg/L to about 8 mg/L; butyrate from about 314 mg/L to about 440 mg/L; conjugated linoleic acid (CLA) from about 50 mg/L to about 80 mg/L; odd and branched fatty acids from about 115 mg/L to about 170 mg/L. In certain embodiments, the composition(s) is substantially free of milk fat supplements, such as anhydrous milk fat, buttermilk, dairy lipid-enriched fractions, butter, and the like.

Additionally, in embodiments, the nutritional composition(s) of the present disclosure provides an enhanced level of palmitic acid C16:0 with a sn-2 position stereochemistry which improves digestion and nutrient absorption. In certain embodiments, the composition(s) sources about 80% to 85% of its palmitic acid from milk fat, and has about 34% to about 35% of its C16:0 in the sn-2 position. In some embodiments, the composition(s) is substantially free of structured lipids.

In certain embodiments, the present disclosure also relates to a method for supporting and promoting nutrition in a pediatric subject by administering a nutritional composition which includes up to about 4.5 g/100 kcal of a protein source, wherein the protein sources can comprise dairy proteins and about 0.8 g/100 kcal to about 1.2 g/100 kcal of the protein source can comprise sourced solely from whole milk; up to about 6.0 g/100 kcal of a fat source, wherein about 0.8 g/100 kcal to about 1.5 g/100 kcal of the fat source can comprise milk fat sourced solely from whole milk; up to about 11.4 g/100 kcal carbohydrates, wherein about 1.3 g/100 kcal to about 2 g/100 kcal of the carbohydrates can comprise lactose sourced solely from whole milk, wherein about 20 mg/100 Kcal to about 90 mg/100 Kcal can comprise long chain polyunsaturated fatty acids and wherein about 0.5 g/100 kcal to about 1 g/100 kcal can comprise a prebiotic. The whole milk can be present in the nutritional composition at a level of about 3 g/100 kcal to about 5 g/100 kcal.

The nutritional composition of the method of the present disclosure is, in some embodiments, substantially free of skim milk or skim milk powder; substantially free of dairy lipid enriched fractions, buttermilk, butter, anhydrous milk fat, and the like; and substantially free of plant-derived proteins.

In embodiments, the whole milk comprises milk fat that contributes the following to the nutritional composition of the disclosed method: about 7 mg/100 kcal to about 11 mg/100 kcal of phospholipids, about 1.5 mg/100 kcal to about 2.5 mg/100 kcal of sphingolipids; about 1 to about 2 mg/100 kcal of gangliosides; about 5.5 mg/100 kcal to about 9.5 mg/100 kcal of cholesterol; about 10 mg/100 kcal to about 15 mg/100 kcal of conjugated linoleic acid; about 60 mg/100 kcal to about 85 mg/100 kcal of butyrate; about 20 mg/100 kcal to about 35 mg/100 kcal of odd- and branched-chain fatty acids. Moreover, the milk fat contributes to the nutritional composition from about 80% to about 85% of palmitic acid in some embodiment, wherein the palmitic acid contributed by the milk fat has about 34% to about 36% positioned in the sn-2 position of the triglyceride. Additionally, in some embodiments the nutritional composition is substantially free of structured lipids.

In embodiments, whey protein concentrate 80% comprises from about 28% to about 36% of the protein; in other embodiment, whey protein concentrate 80 comprises from about 0.6 g/100 kcal to about 0.8 g/100 kcal.

In certain embodiments, demineralized 90% whey is a source of dairy protein in the nutritional composition of the method, where the weight ratio of whole milk to demineralized 90% whey is from about 1:1 to about 1:1.4; in some embodiments demineralized 90% whey comprises from about 18% to about 32% of the protein, or about 0.32 g/100 kcal to about 0.55 g/100 kcal. In embodiments, the fat source of the nutritional composition of the present method further comprises high oleic sunflower oil, linoleic sunflower oil, high oleic safflower oil, coconut oil, canola oil, or combinations thereof, and is substantially free of palm oil, palm olein, palm kernel oil, soybean oil. In some embodiments the weight ratio of milk fat:vegetable oil is from about 1:3 to about 1:5.

The vegetable oils which can be used as the fat in the nutritional composition of the method of the present disclosure are produced so as to have lower levels of glycidol esters and mono- and di-chloro propane diol contaminants than non-mitigated commercially available vegetable oils, in certain embodiments. The vegetable oils used as the fat source contribute less than 50 parts per billion (ppb) of glycidol esters to the composition. Moreover, in embodiments the lactose comprises from about 10.2 g/100 kcal to about 11 g/100 kcal.

It is to be understood that both the foregoing general description and the following detailed description present embodiments of the disclosure and are intended to provide an overview or framework for understanding the nature and character of the disclosure as it is claimed. The description serves to explain the principles and operations of the claimed subject matter. Other and further features and advantages of the present disclosure will be readily apparent to those skilled in the art upon a reading of the following disclosure.

### DETAILED DESCRIPTION

Reference now will be made in detail to the embodiments of the present disclosure, one or more examples of which are set forth hereinbelow. Each example is provided by way of explanation of the nutritional composition of the present disclosure and is not a limitation. In fact, it will be apparent to those skilled in the art that various modifications and variations can be made to the teachings of the present disclosure without departing from the scope of the disclosure. For instance, features illustrated or described as part of one embodiment, can be used with another embodiment to yield a still further embodiment.

Thus, it is intended that the present disclosure covers such modifications and variations as come within the scope of the appended claims and their equivalents. Other objects, features and aspects of the present disclosure are disclosed in or are apparent from the following detailed description. It is to be understood by one of ordinary skill in the art that the present discussion is a description of exemplary embodiments only and is not intended as limiting the broader aspects of the present disclosure.

The present disclosure relates generally to administration of nutritional compositions to an infant. Additionally, the disclosure relates to methods for incorporating milk fat and providing a composition having lipid components which more closely mimic human milk without the need of addition of lipid-enriched supplements.

“Nutritional composition” means a substance or formulation that satisfies at least a portion of a subject's nutrient requirements. The terms “nutritional(s)”, “nutritional formula(s)”, “enteral nutritional(s)”, and “nutritional supplement(s)” are used as non-limiting examples of nutritional composition(s) throughout the present disclosure. Moreover, “nutritional composition(s)” may refer to liquids, powders, gels, pastes, solids, concentrates, suspensions, or ready-to-use forms of enteral formulas, oral formulas, formulas for infants.

“Infant” means a human subject ranging in age from birth to not more than one year and includes infants from 0 to 12 months corrected age. The phrase “corrected age” means an infant's chronological age minus the amount of time that the infant was born premature. Therefore, the corrected age is the age of the infant if it had been carried to full term. The term infant includes low birth weight infants, very low birth weight infants, and preterm infants.

“Infant formula” means a composition that satisfies at least a portion of the nutrient requirements of an infant. In the United States, the content of an infant formula is dictated by the federal regulations set forth at 21 C.F.R. §§ 106 and 107. These regulations define macronutrient, vitamin, mineral, and other ingredient levels in an effort to simulate the nutritional and other properties of human breast milk.

“Nutritionally complete” means a composition that may be used as the sole source of nutrition, which would supply essentially all of the required daily amounts of vitamins, minerals, and/or trace elements in combination with proteins, carbohydrates, and lipids (primarily present as fats). Indeed, “nutritionally complete” describes a nutritional composition that provides adequate amounts of carbohydrates, lipids, essential fatty acids, proteins, essential amino acids, conditionally essential amino acids, vitamins, minerals and energy required to support normal growth and development of a subject.

A nutritional composition that is “nutritionally complete” for an infant will, by definition, provide qualitatively and quantitatively adequate amounts of all carbohydrates, lipids, essential fatty acids, proteins, essential amino acids, conditionally essential amino acids, vitamins, minerals, and energy required for growth of the full term infant.

“Whole milk” refers to mammalian milk, including milk obtained from cows, sheep, and goats, containing at least 2.75% fat and at least about 240 calories per liter. Generally, whole milk contains between 3% and 5% fat. The term “whole milk” as used herein also refers to dry whole milk (as defined in 37 C.F.R. § 131.147) and whole milk powder (as defined in CODEX Alimentarius CSX 207-1999). In some embodiments, the whole milk used in the nutritional compositions of the present disclosure is organic whole milk, meaning the milk complies with the requirements of the national organic program as set out in 7 C.F.R. § 205, including that the milk is obtained from a cow that has not been treated with antibiotics, has not been given hormones, and has been fed at least 30% of its diet on pasture.

“Milk fat” means the non-aqueous portion of the whole milk from mammals.

“Triglycerides” means an organic molecule in which alcohol glycerol is esterified to one or more different fatty acids.

“Fatty acids” means an organic molecule with a carboxylic acid group in one end attached to a hydrocarbon chain. The hydrocarbon chain may be as simple as one-carbon length to chains with increasing number of carbons, with presence of double bonds in different positions and stereochemical configurations, and possibly branched. Rarely fatty acids are found free in nature; commonly they exist as salts or in combination with other molecules, such as, but not limited to, glycerol, phosphate groups, and carbohydrates.

“Branched Chain Fatty Acid” (BCFA) means a fatty acid containing a carbon constituent branched off the carbon chain. Typically, the branch is an alkyl branch, especially a methyl group, but ethyl and propyl branches are also known. This includes branched chain fatty acids with an even number of carbon atoms in the carbon chain. Examples of these can be isomers of tetradecanoic acid and hexadecenoic acid. The addition of the methyl branch lowers the melting point compared with the equivalent straight chain fatty acid. Examples of these can be isomers of pentadecylic and heptadecanoic acids.

“Odd-Chain Fatty Acid” is a subset of BCFA that has an odd number of carbon atoms and has one or more alkyl branches on the carbon chain. The main odd- and branched-chain fatty acids found in bovine milk include, but are not limited to, the isomers of pentadecanoic acid and heptadecanoic acid. Odd-chain fatty acids are usually referred to together with BCFA as odd- and branched-chain fatty acids (“OBCFA”).

“Structured lipids” means triglyceride molecules that have been obtained through a chemical or an interesterification enzymatic process where fatty acids are rearranged on the glycerol backbone to achieve a particular position. They mostly intend to improve vegetable oils as human milk fat substitutes by enhancing the levels of palmitic acid in the sn-2 position and of oleic acids in the terminal sn-1 and sn-3 positions. These molecules are also known as OPO structured lipids.

“Milk fat globule membrane” (MFGM) refers to a three-layer membrane that surrounds the fat droplet as it is secreted from the mammary gland. It comprises material from the milk secreting cells. Examples of the broad-family of molecules that are components of MFGM include but are not limited to, triglycerides, polar lipids, neutral lipids, glycoproteins, and glycolipids. More specifically, the MFGM comprises a three-layered membrane formed by polar lipids, neutral lipids, triglycerides, glycoproteins, and glycolipids. Polar lipids are comprised of glycerophospholipids, such as phosphatidylcholine (PC), phosphatidylethanolamine (PE), phosphatidylserine, and phosphatidylinositol; and sphingolipids, such as sphingomyelin (SM), gangliosides and cerebrosides. PC, PE, and SM constitute about 90% of the total. Cholesterol is the most abundant neutral lipid. Moreover, MFGM glycoproteins are located on the surface with mucin, xanthine dehydrogenase/oxidase, cluster differentiation 36, butyrophilin, and lactadherin (also known as glycosylated PAS 6/7) the most abundant. In both, human and bovine milk fat, the MFGM components are broadly similar; with minor differences, such as an average higher sphingomyelin content in human MFGM.

“Phospholipids” means an organic molecule that contains a diglyceride, a phosphate group and a simple organic molecule. Examples of phospholipids include but are not limited to, phosphatidic acid, phosphatidylethanolamine, phosphatidylcholine, phosphatidylserine, phosphatidylinositol, phosphatidylinositol phosphate, phosphatidylinositol bisphosphate and phosphatidylinositol triphosphate, ceramide phosphorylcholine, ceramide phosphorylethanolamine and ceramide phosphoacylglycerol. This definition further includes sphingolipids such as sphingomyelin. Glycosphingolipids are quantitatively minor constituents of the MFGM, and consist of cerebrosides (neutral glycosphingolipids containing uncharged sugars) and gangliosides. Gangliosides are acidic glycosphingolipids that contain sialic acid (N-acetylneuraminic acid, also known as NANA) as part of their carbohydrate moiety. There are different types of gangliosides that vary in the nature and length of their carbohydrate side chains, and the number of sialic acids attached to the molecule.

“Prebiotic ” means a non-digestible food ingredient that beneficially affects the host by selectively stimulating the growth and/or activity of one or a limited number of bacteria in the digestive tract that can improve the health of the host.

All percentages, parts and ratios as used herein are by weight of the total formulation, unless otherwise specified.

The nutritional formulation of the present disclosure may also be substantially free of any optional or selected ingredients described herein, provided that the remaining nutritional formulation still contains all of the required ingredients or features described herein. In this context, and unless otherwise specified, the term “substantially free” means that the selected formulation contains less than a functional amount of the optional ingredient, typically less than 0.1% by weight, and also, including zero percent by weight of such optional or selected ingredient.

All references to singular characteristics or limitations of the present invention shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The compositions and methods of the present disclosure, including components thereof, can comprise, consist of, or consist essentially of the essential elements and limitations of the invention described herein, as well as any additional or optional ingredients, components or limitations described herein or otherwise useful in nutritional formulations.

As used herein, the term “about” should be construed to refer to both of the numbers specified in any range. Any reference to a range should be considered as providing support for any subset within that range.

As noted, the nutritional composition of the present disclosure comprises whole milk. In certain embodiments, the whole milk is provided as whole milk powder or dry whole milk. In some embodiments, the whole milk is included in the nutritional composition of the present disclosure at a level of about 3 g/100 kcal to about 5 g/100 kcal. In certain embodiments, in powder form, whole milk is from about 17 g/100 g to about 26 g/100 g of composition. In some embodiments, the whole milk is organic and, in embodiments, is sourced from grass-fed cows.

Total fat in the nutritional composition disclosed herein, including milk fat as well as vegetable oils, is in the range of about 36 g/L to about 40 g/L, and provides about 48% to 52% of the total calories. In certain embodiments, total fat is about 5.2 g/100 Kcal to about 6.0 g/100 kcals. The milk fat in the nutritional composition disclosed herein, excluding fat sourced from vegetable oils, is in the range of about 0.8 g/100 kcal to about 1.5 g/100 kcal. In other embodiments, the weight ratio of milk fat to vegetable oil may be between about 1:3 and about 1:5. In certain embodiments, milk fat comprises about 16% to about 22% of the total fat of the composition. Per 100 g of a powder composition, milk fat is present at a level of about 4.5 g to about 7.0 g, in some embodiments.

Human milk fat comprises about 43% long-chain saturated fatty acids, while bovine milk has a content of about 67%. Oleic C18:1 and palmitic C16:0 acids are the most abundant fatty acids in both milk fats; however, in reverse proportions. Human milk fat has a fatty acid content of 34% C18:1 and 22% C16:0; while bovine milk fat has a fatty acid content of 22% C18:1 and 30% C16:0. Regarding long-chain unsaturated fatty acids, human milk fat is higher in the essential linoleic C18:2 n-6 and alpha-linolenic C18:3 n-3 acids compared to bovine milk fat. However, as a result of microbial rumen fermentation, bovine milk fat has a higher level of conjugated linoleic acid (C18:2 cis 9, trans 11) and of short chain fatty acids butyric C4:0, caproic C6:0 and caprylic C8:0.

Conventional commercial infant formulas meet the nutritional fat and calorie requirement using solely economical and ready-available vegetable oils. These oils, compared to human and bovine milk fat, are mostly low in saturated fatty acids and higher in long-chain unsaturated fatty acids. Coconut oil and palm kernel oil are sourced for saturated lauric C12:0, myristic C14:0 acids. Palm oil and palm olein for saturated palmitic C16:0 and unsaturated oleic C18:1 fatty acids. Rapeseed oil, canola oil, sunflower oil, and soybean oil are sourced for the unsaturated oleic C18:1, linoleic C18:2, and linolenic C18:3 acids.

Lipid digestion through the action of gastric and pancreatic lipases has a stereoselectivity for triglycerides end positions (sn-1 and sn-3). The free fatty acids released from the triglyceride sn-1 and sn-3, plus the remaining sn-2 mono-glyceride become available for absorption through the intestinal membrane. Palm oil and palm olein with about 80% of their C16:0 located in triglyceride end positions release free palmitic acid that binds calcium and creates insoluble palmitate salts that are excreted in the stools. Ultimately, this binding reduces the bioavailability of calcium and palmitic acid.

In human milk fat, palmitic acid C16:0 comprises about 20% to about 25% of its fatty acids, and about 75% are located in the sn-2 position. In bovine milk fat, C16:0 is about 30% of fatty acids, and about 45% are located in the sn-2 position. In contrast, infant formulas based on vegetable oils have less than 15% C16:0 in sn-2 position. Studies comparing infant formulas with and without palm olein showed the latter to produce softer stools, improve fat absorption, reduce C16:0 excretion, and increase calcium retention. Infant formulas supplemented with structured lipids, modified to increase the sn-2 C16 content, have shown superior lipid digestion benefits when compared to formulas with low sn-2 palmitate; however, not as compared to those seen in breastfed infants.

In the present disclosure, the palmitic acid that originates from milk fat is about 80% to about 85% of the total C16:0 in the composition. Furthermore, the palmitic acid that is located in the sn-2 position of the triglyceride is about 34% to about 36%. In typical skim milk-based formulations supplemented exclusively with vegetable oils about 100% of the palmitic acid originates from the vegetable oil, and about 10% is located in the sn-2 position.

In addition to the advantages discussed hereinabove, the use of whole milk in the disclosed composition permits a balanced contribution of protein, fat, carbohydrates, and fatty acids to promote development in an infant. Indeed, the fatty acid profile of the disclosed compositions more closely matches human breast milk in key constituents, such as n-9 oleic acid and palmitic acid, than many skim milk-based formulations. Moreover, comparatively, the use of whole milk in the formulations disclosed herein provides increased levels of n-9 oleic acid, which is the predominant fatty acid in human milk and has been suggested as having beneficial effects.

The milk fat originating from the whole milk used in the nutritional composition may comprise, in some embodiments, butyric acid. Butyric acid, also known as butanoic acid C4:0, is a volatile short chain fatty acid with a 4-carbon chain that is synthesized in the cow's rumen by microbial fermentation of carbohydrates and proteins. In certain embodiments, butyric acid may be esterified to a glyceride or in a salt form as butyrate. Without being bound by any particular theory, it is believed that butyrate can nourish colonic mucosa and is also potentially involved in the intestinal immune regulation of microflora. In some embodiments, the concentration of butyrate can be in the range of about 60 mg/100 kcal to about 85 mg/100 kcal; when a powder embodiment is reconstituted with water it is about 310 mg/L to about 450 mg/L. In the present disclosure, this level of butyric acid is achieved via the milk fat from the whole milk, and not through the addition of supplements that may degrade or volatilize during processing.

In addition, the milk fat in the whole milk may comprise, in some embodiments, conjugated linoleic acid, also known as rumenic acid. CLA, or conjugated cis-9 trans-11 linoleic acid (C18:2 cis-9 trans-11) is a long-chain unsaturated fatty acid with 18-carbon and two carbon double bonds. It is synthesized in the cow's rumen by biohydrogenation of linoleic acid (18:2 cis-9, cis-12) of bacteria that express linoleic acid isomerase. CLA is currently not classified by the United States Food and Drug Administration (FDA) as a trans-fat, and was given a “Generally Regarded as Safe (GRAS)” designation in 2008, exempting it from classification as a trans-fat on nutrition labels. Without being bound by any particular theory, it is believed that CLA is involved in the modulation of the immune function. In some embodiments, the concentration of CLA can be in the range of about 10 mg/100 kcal to about 15 mg/100 kcal; when a powder embodiment is reconstituted with water it is about 50 mg/L to about 80 mg/L. The milk fat, in some embodiments, also comprises odd-chain and branched-chain fatty acids (OBCFA), which are typically present in low amounts in milk, that is about 0.8 to about 1.0% of total fatty acids, but exert a significant impact on human health. Typical odd-chain fatty acids are pentadecanoic C15:0 and heptadecanoic C17:0 acids; while for branched-chain fatty acids are iso C13:0, iso C14:0, iso C15:0, iso C16:0, iso C17:0, anteiso C15:0, and anteiso C17:0. In these fatty acids, the branch point is located in the penultimate (iso) or antepenultimate (anteiso) carbon of the chain. Without being bound by any particular theory, it is believed that OBCFA originates from the cell membranes of rumen bacteria and have been shown to reduce the incidence of necrotizing enterocolitis in newborns. In some embodiments, OBCFAs are present at about 20 mg/100 kcal to about 35 mg/100 kcal of the nutritional composition disclosed herein; when a powder composition is reconstituted with water, the composition includes OBCFA from about 110 mg/L to about 165 mg/L in certain embodiments.

Additionally, the whole milk component of the nutritional composition of the present disclosure acts as a source of milk fat globule membrane (MFGM), cholesterol and phospholipids, considered advantageous for an infant's growth and development. Whole milk, different from defatted or skim milk, retains the entire milk fat component. The milk fat droplets are surrounded by a milk fat globule membrane (MFGM) that maintains the fat droplet dispersed, protects from oxidation, and assists in lipid digestion. During bovine milk processing MFGM is removed with the milk fat during centrifugation to produce skim milk. The MFGM is unique to mammal milk and is not present in vegetable oils. Hence, infant formulas that use nonfat milk and vegetable oils are lacking MFGM components. It is believed that compositions enriched with MFGM components can lead to improvement in cognitive development, reduction in newborn infections, support gut-brain axis development, and increased endogenous conversion of omega-3 fatty acids.

For instance, the disclosed composition generally includes, in some embodiments, MFGM present at a level of about 0.16 to about 0.32 g/100 g of composition; in some embodiments the level is at least about 0.24 g MFGM per 100 g of composition when in powder form; when reconstituted with water, the composition includes at least about 0.32 g MFGM per liter. And, MFGM is generally present in the composition of this disclosure at a level equivalent to at least about 1.6% of the total protein and at least about 0.6% of the total fat, in certain embodiments. The composition also contains cholesterol that is closer to the content of typical human milk than found in typical skim-milk based formulas. In some embodiments, cholesterol is present at a level of about 0.01 to about 0.04 g/100 g of composition; in some embodiments the level is at least 0.03 g cholesterol per 100 g of composition when in powder form; when reconstituted with water, the composition includes at least 0.04 g cholesterol per liter in certain embodiments. And, cholesterol is generally present in the composition of this disclosure at a level equivalent to at least about 0.09% of the total fat, in some embodiments. The composition also contains milk phospholipids; in embodiments, milk phospholipids are present at a level of about 0.04 to about 0.07 g/100 g of composition; in some embodiments the level is at least 0.05 g per 100 g.

In terms of nutritional value, the disclosed composition generally includes, in some embodiments, milk fat phospholipids present at a level of about 7 mg/100 kcal to about 11 mg/100 kcal; in other embodiments it is about 9 mg/100 kcal to about 10 mg/100 kcal; when a powder embodiment is reconstituted with water, the composition includes about 55 mg/L to about 85 mg/L of milk fat phospholipids. In some embodiments, milk fat sphingolipids are present at a level of about 1.5 mg/100 kcal to about 2.5 mg/100 kcal; when a powder embodiment is reconstituted with water, the composition includes at about 12 mg/L to about 20 mg/L of milk fat sphingolipids. In certain embodiments, milk fat gangliosides are present at a level of about 1 mg/100 Kcal to about 2 mg/100 kcal; when a powder embodiment is reconstituted with water, the composition includes at about 5.5 mg/L to about 9 mg/L of milk fat gangliosides. And, as noted, the milk fat in whole milk can also contribute cholesterol, which in some embodiments, is present at a level of about 5.5 mg/100 kcal to about 9.5 mg/100 kcal; when in powder form from about 40 mg to about 50 mg of milk fat cholesterol per 100 g of composition; when reconstituted with water, the composition includes about 25 mg/L to about 40 mg/L of milk fat cholesterol.

The present disclosure contemplates including whole milk in a nutritional composition as a protein source. In some embodiments, at least about 35% of the protein source comprises whole milk. In other embodiments, at least about 40% of the protein source comprises whole milk; in still other embodiments at least about 43% of the protein source comprises whole milk. In certain embodiments, the whole milk is provided as whole milk powder or dry whole milk. In an embodiment the whole milk comprises up to about 55% of the protein. In certain embodiments, the disclosed composition is substantially free of skim milk or skim milk powder.

The protein source of the nutritional composition of the present disclosure can comprise, in addition to whole milk, a source of whey, such as whey powder and whey protein concentrate. In an embodiment, at least about 20% of the protein is provided as whey protein concentrate; in other embodiments the source of protein comprises at least about 23% whey protein concentrate. In certain embodiments, whey protein concentrate comprises up to about 33% of the protein source. With respect to whey powder, the protein source can comprise at least about 18% whey powder in an embodiment of the present disclosure. In other embodiments the source of protein comprises at least about 21% whey powder; in certain embodiments, whey powder comprises up to about 30% of the protein source.

In some embodiments, the weight ratio of whole milk powder:whey protein concentrate powder is from about 3:1 to about 5:1. In certain embodiments, at least about 28% to about 36% of the protein is provided by the protein in whey protein concentrate or about 0.60 g/100 kcal to about 0.80 g/100 kcal. With respect to whey powder, in particular 90% demineralized whey powder (DM90 whey), in some embodiments, the weight ratio of whole milk powder:DM90 whey is about 1:1 to about 1:1.4. For instance, in certain embodiments at least about 18% to about 32% of the protein is provided by the protein in DM90 whey powder or about 0.32 g/100 kcal to about 0.55 g/100 kcal.

Other protein sources which may be included in the nutritional composition of the present disclosure can include casein, hydrolyzed protein, amino acids, and the like. In an embodiment, the composition is substantially free of plant-based proteins. In another embodiment, the composition is free of nonfat milk or nonfat milk solids.

In a particular embodiment of the nutritional composition, the whey:casein ratio of the protein source is similar to that found in human breast milk. In an embodiment, the protein source comprises from about 50% to about 70% whey protein and from about 30% to about 50% casein. In still other embodiments, the whey:casein ratio is between about 55:45 and about 65:35.

In some embodiments, protein comprises from about 7.5% to about 10.5% of the caloric content of the disclosed nutritional composition, in some embodiments; in other embodiments, protein comprises about 8.5% to about 10% of the caloric content. In certain embodiments, the nutritional composition comprises between about 1 g and about 5 g of the protein source per 100 kcal. In other embodiments, the nutritional composition comprises between about 1.5 g and about 3.5 g of protein per 100 kcal. Per 100 g of the composition, protein is present at a level of about 10.0 g to about 12.9 g, in some embodiments.

The nutritional composition also comprises a fat or lipid source. As noted above, whole milk comprises at least about 12% of the fat source in some embodiments. In other embodiments, whole milk comprises at least about 16% of the fat source. In yet other embodiments, whole milk comprises no more than about 30% of the fat source; or, in some embodiments, whole milk comprises no more than about 25% of the fat source.

Suitable fat sources for the nutritional composition of the present disclosure besides milk fat from whole milk can include, in some embodiments, vegetable and plant oils such as high oleic sunflower oil, high oleic safflower oil, coconut oil, canola oil, linoleic sunflower oil. Indeed, in some embodiments the inclusion of sunflower oil or safflower oil as a fat source can provide a source of tocopherols (d-alpha-tocopherol, d-beta tocopherol, d-gamma-tocopherol, d-delta tocopherol, etc.) believed to promote healthy development. Other fat sources which can be included in some embodiments as corn oil, sunflower oil, soybean oil, palm olein oil, evening primrose oil, rapeseed oil, olive oil, flaxseed (linseed) oil, cottonseed oil, safflower oil, palm stearin, palm kernel oil, wheat germ oil, evening primrose oil, avocado oil, and olive oil. However, in some embodiments, the composition of the present disclosure is substantially free of soybean oil, palm oil, and/or palm olein oil.

Moreover, the vegetable oils can, in certain embodiments, be sourced organic and produced (such as through agriculture and refining practices having implemented mitigated techniques) to provide for oils which have lower levels of glycidol esters and mono- and di-chloro propane diol contaminants than common commercially available oils. For instance, in some embodiments the oils used as the fat source for the composition of the present disclosure contribute less than 50 parts per billion (ppb) of glycidol esters to the composition. In addition, in certain embodiments fat sources such as medium chain triglyceride oils, egg yolk lipid, and marine sources, such as fish oils, marine oils, single cell oils can be employed. That said, in some embodiments, the composition of the present disclosure is substantially free of added milk fat, anhydrous milk fat, milk fat fractions, lipid-enriched whey fractions, butter fat, buttermilk, cream, or butter.

In some embodiments, the fat source may be present in the nutritional composition in an amount from about 1 g/100 kcals to about 11 g/100 kcals. In still some embodiments, the fat source may be present in an amount from about 2 g/100 kcals to about 10 g/100 kcals. Per 100 g of the composition, fat is present at a level of about 22.0 g to about 35.0 g, in some embodiments. In some embodiments, fat comprises from about 45% to about 59% of the caloric content of the disclosed nutritional composition, in some embodiments; in other embodiments, fat comprises about 48% to about 55% of the caloric content of the composition.

In some embodiments, the nutritional composition comprises at least one carbohydrate such as lactose. Whole milk can function as a source of lactose for the disclosed composition; in some embodiments, lactose powder and demineralized whey can also act as sources of lactose. In embodiments, lactose powder is the source of lactose. In the present disclosure, whole milk, whey powder, and whey protein concentrate also function as a source of lactose for the disclosed composition. In some embodiments, total lactose comprises about 40% to about 43% of the caloric content of the disclosed nutritional composition. In certain embodiments, the nutritional composition comprises about 10.2 g to about 11 g of the lactose per 100 kcal. In some embodiments, about 1.3 g/100 kcal to about 2 g/100 kcal of the carbohydrates comprise lactose originating solely from whole milk. Per 100 g of the composition, lactose is present at a level of about 53 g to about 55 g, in some embodiments.

In addition, the carbohydrate can in some embodiments also include others used in the art, e.g., glucose, fructose, corn syrup solids, maltodextrins, sucrose, starch, rice syrup solids, and the like. In certain embodiments, however, the nutritional composition of the present disclosure is substantially free of corn syrup solids, rice syrup solids, maltodextrin, sucrose, and/or starch. The amount of the carbohydrate component in the nutritional composition typically can vary from between about 5 g/100 kcal and about 22 g/100 kcal. In some embodiments, the amount of carbohydrate is between about 6 g/100 kcal and about 19 g/100 kcal. In other embodiments, the amount of carbohydrate is between about 9 g/100 kcal and about 16 g/100 kcal. Lactose is preferred as the carbohydrate, in some embodiments.

In some embodiments, the nutritional composition of the present disclosure can also include one or more prebiotics like galacto-oligosaccharides, fructo-oligosaccharides, and inulin, and the like, and/or a source of long chain polyunsaturated fatty acids (LCPUFAs).

Prebiotics useful in the present disclosure may include galacto-oligosaccharides (GOS), fructo-oligosaccharides (FOS), inulin, and other molecules of the like of human milk oligosaccharides, such as 2′-fucosyllactose (2′-FL), 3-fucosyllactose (3-FL), 3′-sialyllactose (3′-SL), 6′-sialyllactose (6′-SL), difucosyllactose (DiFL), and lacto-N-neotetraose (LNnT), that have been approved as generally recognized as safe (GRAS) by the United States Food and Drug Administration (FDA). In an embodiment, an example of prebiotic source may be a GOS-enriched syrup resulting from the beta-galactosidase transgalactosylation reaction of lactose and other galactosyl-glycans. The resulting GOS has a structure glucose-(galactose)n, where n is the degree of polymerization that might range from about 1 to about 5. In certain embodiments, the total amount of prebiotic in the composition may be from about 1 g/L to about 10 g/L; in other embodiments may be from about 2.5 g/L to about 4.5 g/L. In some embodiments, the prebiotic amount may represent about 0.5 g/100 kcal to about 1 g/100 kcal.

In some embodiments, suitable LCPUFAs include docosahexaenoic acid (DHA), a C22:6 omega-3; and arachidonic acid (ARA), a C20:4 omega-6. In certain embodiments, the weight ratio of ARA:DHA is about 1:1 to about 4:1, more specifically 2:1. In other embodiments, the composition comprises about 20 mg/100 Kcal to about 90 mg/100 Kcal of LCPUFAs. If utilized, an example of this LCPUFA source may be egg yolk lipids, fish oil, fungal oil, and algal oil. In certain embodiments, the LCPUFA-rich oil is blended with another vegetable oil present in the composition, such as high oleic sunflower oil. The nutritional composition may be supplemented with oils containing DHA and/or ARA using standard techniques known in the art. For example, DHA and ARA may be added to the composition by replacing an equivalent amount of an oil, such as high oleic sunflower oil, that may be present in the composition. As another example, the oils containing DHA and ARA may be added to the composition by replacing an equivalent amount of the rest of the overall fat blend normally present in the composition without DHA and ARA.

One or more vitamins and/or minerals may also be added into the nutritional composition in amounts sufficient to supply the daily nutritional requirements of an infant.

In embodiments, the composition of this disclosure may optionally include, but is not limited to, one or more of the following vitamins and minerals or derivations thereof: folic acid, potassium iodide, tricalcium phosphate, ascorbic acid, potassium phosphate dibasic, biotin, choline bitartrate, d-alpha tocopheryl acetate, zinc gluconate, d-calcium pantothenate, copper gluconate, ferrous gluconate dihydrate, inositol, magnesium oxide, manganese sulfate monohydrate, niacinamide, potassium chloride, potassium citrate, pyridoxine hydrochloride, riboflavin, thiamin hydrochloride, Vitamin A palmitate, cyanocobalamin, cholecalciferol, phytonadione, sodium selenite, as well as others deemed beneficial and known in the art.

The disclosed nutritional composition(s) is, in certain embodiments, an infant formula providing complete nutrition; it may be provided in any form known in the art, including as a liquid, a liquid concentrate, a reconstitutable powdered milk substitute or a ready-to-use product. Moreover, the nutritional composition of the present disclosure may be standardized to a specific caloric content, such as between about 17 and 23 kcal/fl. oz. in some embodiments. It may also be provided as a ready-to-use product, or it may be provided in a concentrated form. In some embodiments, the nutritional composition is in powder form.

The nutritional composition of the present disclosure is not limited to compositions comprising nutrients specifically listed herein. Any nutrients may be delivered as part of the composition for the purpose of meeting nutritional needs and/or in order to optimize the nutritional status in a subject.

Moreover, in some embodiments, the nutritional composition is nutritionally complete, containing suitable types and amounts of fats (lipids), carbohydrates, proteins, vitamins and minerals to be a subject's sole source of nutrition. Indeed, the nutritional composition may optionally include any number of proteins, peptides, amino acids, fatty acids, probiotics and/or their metabolic by-products, prebiotics, carbohydrates and any other nutrient or other compound that may provide many nutritional and physiological benefits to a subject. Further, the nutritional composition of the present disclosure may comprise flavors, flavor enhancers, sweeteners, pigments, vitamins, minerals, therapeutic ingredients, functional food ingredients, food ingredients, processing ingredients or combinations thereof.

The nutritional compositions of the present disclosure may optionally include one or more emulsifiers that may be added for stability of the final product. Examples of suitable emulsifiers include, but are not limited to, lecithin (e.g., from vegetable sources, such as sunflower, safflower, canola, and rapeseed), egg lecithin, alpha lactalbumin and/or mono- and di-glycerides, and mixtures thereof. Other emulsifiers are readily apparent to the skilled artisan and selection of suitable emulsifier(s) will depend, in part, upon the formulation and final product. However, in some embodiments, the nutritional composition of the present disclosure is substantially free of soybean lecithin.

In addition, the disclosure also provides a method which includes providing and/or administering to an infant a nutritional composition comprising protein, fat and carbohydrates, wherein whole milk is present as a source of protein, fat, and carbohydrates. More specifically, in some embodiments the disclosure relates to a method for providing and/or administering to an infant a nutritional composition comprising at least about 18% whole milk, especially whole milk powder or dry whole milk, wherein at least about 35% of the source of protein and at least about 12% of the source of fat comprises whole milk.

### EXAMPLES

### Example 1

### Formulation Example

Table 1 provides an example embodiment of an infant formula including whole milk as described herein. This example provides the amount of each ingredient to be included per 100 kcal of nutritional composition.

TABLE 1
Profile of an example infant formula

| Nutrient | per 100 kcal |
|---|---|
| Whole milk powder (g) | 4.14 |
| Whey protein concentrate (g) | 0.78 |
| Whey powder (g) | 4.13 |
| Lactose (g) | 5.31 |
| Vegetable oil blend (g) | 4.12 |
| Lecithin Concentrate (mg) | 280 |
| Dry vitamin and mineral Premix (mg) | 440 |

### Example 2

### Formulation Example

Table 2 provides an additional example embodiment of an infant formula including whole milk as described herein. This example provides the amount of each ingredient to be included per 100 g of nutritional composition.

TABLE 2
Profile of an example infant formula

| Nutrient | per 100 g |
|---|---|
| Whole milk powder (g) | 19-23 |
| Whey protein concentrate (g) | 3-5 |
| Whey powder (g) | 19-23 |
| Lactose (g) | 25-31 |
| Vegetable oil blend (g) | 20-24 |
| Lecithin Concentrate (g) | 1-2 |
| Dry vitamin and mineral Premix (g) | 2-3 |

### Example 3

### Formulation Example

Table 3 provides yet another example embodiment of an infant formula including whole milk as described herein, including LCPUFAs, vitamins, minerals, etc. This example provides the amount of each ingredient to be included per 100 kcal of nutritional composition.

TABLE 3
Profile of an example infant formula

| Nutrient | units | per 100 kcal |
|---|---|---|
| Protein | g | 2.2 |
| Fat | g | 5.5 |
| Milk fat | g | 1.2 |
| Whole Milk | g | 3.4 |
| Linoleic Acid | mg | 500 |
| Alpha-Linolenic Acid | mg | 140 |
| Conjugated linoleic Acid | mg | 12 |
| Docosahexaenoic Acid | mg | 25.9 |
| Carbohydrates | g | 10.6 |
| Vitamin A | IU | 300 |
| Vitamin D | IU | 60 |
| Vitamin E | IU | 1.7 |
| Vitamin K | mcg | 11 |
| Thiamin | mcg | 110 |
| Riboflavin | mcg | 140 |
| Vitamin B6 | mcg | 60 |
| Vitamin B12 | mcg | 0.3 |
| Niacin | mcg | 850 |
| Folic Acid | mcg | 18 |
| Pantothenic Acid | mcg | 800 |
| Biotin | mcg | 2.5 |
| Vitamin C | mg | 12 |
| Choline | mg | 20 |
| Inositol | mg | 4 |
| Calcium | mg | 70 |
| Phosphorus | mg | 45 |
| Magnesium | mg | 7 |
| Sodium | mg | 35 |
| Potassium | mg | 90 |
| Chloride | mg | 60 |
| Iron | mg | 1.2 |
| Zinc | mg | 0.7 |
| Iodine | mcg | 15 |
| Manganese | mcg | 18 |
| Copper | mcg | 70 |
| Selenium | mcg | 2.8 |

### Example 4

### Formulation Example

Table 4 provides still another example embodiment of an infant formula including whole milk as described herein, including LCPUFAs, vitamins, minerals, etc. This example provides the amount of each ingredient to be included per 100 kcal of nutritional composition.

TABLE 4
Profile of an example infant formula

| Nutrient | units | per 100 kcal |
|---|---|---|
| Protein | g | 2.4 |
| Fat | g | 5.4 |
| Milk fat | g | 1.2 |
| Whole Milk | g | 4.8 |
| Linoleic Acid | mg | 500 |
| Alpha-Linolenic Acid | mg | 136 |
| Conjugated linoleic Acid | mg | 17 |
| Carbohydrates | g | 10.6 |
| Dietary Fiber (GOS) | g | 1 |
| Vitamin A | IU | 300 |
| Vitamin D | IU | 60 |
| Vitamin E | IU | 1.7 |
| Vitamin K | mcg | 11 |
| Thiamin | mcg | 110 |
| Riboflavin | mcg | 140 |
| Vitamin B6 | mcg | 60 |
| Vitamin B12 | mcg | 0.3 |
| Niacin | mcg | 850 |
| Folic Acid | mcg | 18 |
| Pantothenic Acid | mcg | 800 |
| Biotin | mcg | 2.5 |
| Vitamin C | mg | 12 |
| Choline | mg | 20 |
| Inositol | mg | 4 |
| Calcium | mg | 70 |
| Phosphorus | mg | 45 |
| Magnesium | mg | 7 |
| Sodium | mg | 35 |
| Potassium | mg | 90 |
| Chloride | mg | 60 |
| Iron | mg | 1.2 |
| Zinc | mg | 0.7 |
| Iodine | mcg | 15 |
| Manganese | mcg | 18 |
| Copper | mcg | 70 |
| Selenium | mcg | 2.8 |

### Example 5

### Formulation Example

Table 5 provides another example embodiment of an infant formula including whole milk as described herein, including LCPUFAs, vitamins, minerals, etc. This example provides the amount of each ingredient to be included per 100 kcal of nutritional composition.

TABLE 5
Profile of an example infant formula

| Nutrient | units | per 100 kcal |
|---|---|---|
| Protein | g | 2 |
| Fat | g | 5.8 |
| Milk fat | g | 1.1 |
| Whole Milk | g | 4 |
| Linoleic Acid | mg | 500 |
| Alpha-Linolenic Acid | mg | 143 |
| Conjugated linoleic Acid | mg | 14 |
| Docosahexaenoic Acid | mg | 25.9 |
| Arachidonic Acid | mg | 52.5 |
| Carbohydrates | g | 10 |
| Dietary Fiber (GOS) | g | 1 |
| Vitamin A | IU | 300 |
| Vitamin D | IU | 60 |
| Vitamin E | IU | 1.7 |
| Vitamin K | mcg | 11 |
| Thiamin | mcg | 110 |
| Riboflavin | mcg | 140 |
| Vitamin B6 | mcg | 60 |
| Vitamin B12 | mcg | 0.3 |
| Niacin | mcg | 850 |
| Folic Acid | mcg | 18 |
| Pantothenic Acid | mcg | 800 |
| Biotin | mcg | 2.5 |
| Vitamin C | mg | 12 |
| Choline | mg | 20 |
| Inositol | mg | 4 |
| Calcium | mg | 70 |
| Phosphorus | mg | 45 |
| Magnesium | mg | 7 |
| Sodium | mg | 35 |
| Potassium | mg | 90 |
| Chloride | mg | 60 |
| Iron | mg | 1.2 |
| Zinc | mg | 0.7 |
| Iodine | mcg | 15 |
| Manganese | mcg | 18 |
| Copper | mcg | 70 |
| Selenium | mcg | 2.8 |

All references cited in this specification, including without limitation, all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinence of the cited references.

Although preferred embodiments of the disclosure have been described using specific terms, devices, and methods, such description is for illustrative purposes only. The words used are words of description rather than of limitation. It is to be understood that changes and variations may be made by those of ordinary skill in the art without departing from the spirit or the scope of the present disclosure, which is set forth in the following claims. In addition, it should be understood that aspects of the various embodiments may be interchanged in whole or in part. For example, while methods for the production of a commercially sterile liquid nutritional supplement made according to those methods have been exemplified, other uses are contemplated. Therefore, the spirit and scope of the appended claims should not be limited to the description of the preferred versions contained therein.

What is claimed is:

1. A nutritional composition, comprising protein, fat and carbohydrates, wherein whole milk comprises a source of each of the protein, fat, and carbohydrates.

2. The nutritional composition of claim 1, wherein the protein source comprises a whey:casein ratio from about 55:45 to about 65:35 by weight.

3. The nutritional composition of claim 1, wherein the source of protein further comprises whey powder, whey protein concentrate, or combinations thereof.

4. The nutritional composition of claim 1, wherein at least about 43% of the protein source comprises whole milk.

5. The nutritional composition of claim 1, which comprises between about 1 g and about 5 g of the protein source per 100 kcal.

6. The nutritional composition of claims 1, which is substantially free of skim milk or skim milk powder.

7. A method for supporting and promoting nutrition in a pediatric subject by administering to the subject a nutritional composition comprising:
a. up to about 4.5 g/100 kcal of a protein source, wherein the protein source comprises dairy proteins, where about 0.8 g/100 kcal to about 1.2 g/100 kcal of the protein source is sourced solely from whole milk;
b. up to about 6.0 g/100 kcal of a fat source, where about 0.8 g/100 kcal to about 1.5 g/100 kcal of the fat source comprises milk fat sourced solely from whole milk; and
c. up to about 11.4 g/100 kcal of carbohydrates.

8. The method of claim 1, wherein the nutritional composition comprises whole milk present at a level of about 3 g/100 kcal to about 5 g/100 kcal.

9. The method of claim 1, wherein the nutritional composition is substantially free of plant-derived proteins.

10. The method of claim 1, wherein the whole milk comprises milk fat that contributes the following to the nutritional composition:
About 7 mg/100 kcal to about 11 mg/100 kcal of phospholipids, about 1.5 mg/100 kcal to about 2.5 mg/100 kcal of sphingolipids; about 1 to about 2 mg/100 kcal of gangliosides; about 5.5 mg/100 kcal to about 9.5 mg/100 kcal of cholesterol; about 10 mg/100 kcal to about 15 mg/100 kcal of conjugated linoleic acid; about 60 mg/100kcal to about 85 mg/100 kcal of butyrate; about 20 mg/100kcal to about 35 mg/100 kcal of odd- and branched-chain fatty acids.

11. The method of claim 11, wherein palmitic acid is contributed by the milk fat and has about 34% to about 36% positioned in the sn-2 position of the triglyceride.

12. The method of claim 1, wherein the carbohydrate source of the nutritional composition comprises lactose.

13. The method of claim 12, wherein the nutritional composition comprises lactose at a level of about 10.2 g/100 kcal to about 11 g/100 kcal

14. The method of claim 1, wherein the nutritional composition comprises an infant formula or a growing up milk.
